(19) United States
(12) Patent Application Publication
(10) Pub. No.: US 2003/0156554 A1
(43) Pub. Date: Aug. 21, 2003

(54) Method for regulating transmission power in a radiocommunications system

(76) Inventors: Markus Dillinger, Munich (DE); Juergen Gronau, Kankelau (DE); Christian Lueders, Meschede (DE); Markus Quente, Warstein (DE)

Correspondence Address: STAAS & HALSEY LLP, SUITE 700, 1201 NEW YORK AVENUE, N.W., WASHINGTON, DC, 20005, US

(21) Appl. No.: 10/257,441

(22) PCT Filed: Apr. 10, 2001
(86) PCT No.: PCT/DE01/01401

(30) Foreign Application Priority Data
Apr. 11, 2000 (DE) 10017930.4

(51) Int. Cl. H04B 7/185

(52) U.S. Cl. 370/318; 370/328

(57) ABSTRACT

A method and communications system regulate the transmission power of stations in a radiocommunications system for managing a plurality of connections between individual stations which communicate with each other through a radio interface. Usually, an appropriate connection quality value (target-SIR) is set for each individual connection in order to achieve a desired connection quality (SBER). The connection quality value (target-SIR) is modified for the individual connection in order to improve an average connection quality (ΣBER) of a number of connections.

The invention relates to a method for adapting the transmission power control in dependence on the load in packet services in, in particular, a radio communication service with W-CDMA, and to a radio communication system for carrying out the method.

In radio communication systems, information (for example voice, picture information or other data) is transmitted with the aid of electromagnetic waves via a radio interface between the transmitting station and the receiving station (base station and subscriber station, respectively). The electromagnetic waves are radiated with carrier frequencies which are in the frequency band provided for the respective system. For future mobile radio systems with CDMA or TD/CDMA (Time Division/Code Division Multiple Access) transmission methods via the radio interface, for example the UMTS (Universal Mobile Telecommunication System) or other third-generation systems, frequencies in the frequency band of approx. 2000 MHz are provided.

It is the aim of each mobile radio operator to supply the largest possible number of subscribers in his network, or, respectively, the highest possible overall throughput of data per radio cell with, at the same time, the highest possible quality of service. The quality of service can be characterized, e.g. by the maximum permissible bit error rate or, in the case of data services, by the throughput of data (in kbit per second) which must be guaranteed to a subscriber as a minimum. A measure of quality frequently used in standardization is, e.g. that, in certain packet data services (Unrestricted Delay Data (UDD) services), a subscriber must receive at least 10% of his required nominal throughput in order not to be dissatisfied.

In future systems such as the UMTS, the so-called DS-CDMA or “Direct Sequence Code Division Multiple Access” method, i.e. a CDMA method with a direct sequence, is used as the multiplexing method. The performance of this method, i.e. the number of subscribers which can be supplied or, respectively, the total throughput per radio cell which can be achieved, decisively depends on a fast power control (PC) which is optimally adjusted.

Such a power control typically consists of a fast inner and closed control loop (inner loop), in each case in the uplink and in the downlink, and of an outer control loop (outer loop). In the text which follows, an improvement in the control characteristic of the outer loop will be discussed, considering, in particular, the interaction between the two different mechanisms for power control.

The outer loop specifies the nominal value for the fast inner loop. This nominal value is derived from the bit error rate (BER) or block erasure rate (BLER) currently measured and the required quality or target signal-to-interference ratio (SIR) by means of forming a difference.

Methods are generally known in which the target SIR is adapted on the basis of the bit error rates measured or on the basis of repetition rates of packets. These methods attempt to optimize the target SIR for each individual connection but without regard to other connections. However, it is then disadvantageous that control measures on an individual connection affect the totality of the connections and vice-versa so that, in practice, optimization of the power control is made difficult.

The invention is based on the object of providing a method and a radio communication system which provide for better capacity optimization. This object is achieved by the method having the features of claim 1, the radio communication system having the features of claim 12 and stations according to claim 13 for such a communication system. Advantageous developments are the subject matter of subclaims.

It is generally expected that the performance of the power control will depend mainly on an optimally selected target SIR. This can be shown by computer simulations. Such simulations have also shown that the optimum target SIR is not a value which is fixed for a given radio propagation environment but depends on the current load prevailing in the radio network (see also FIG. 2).

The capacity of a CDMA radio network can thus be optimized if the target SIR for the power control is set in dependence on the system load according to the simulation results shown.

The advantage of a central component in controlling the target SIR is the increased ability of the network to react to fast load changes, e.g. if a high-bit-rate data service passes into the cell due to a handover.

Changing the required service level value for one or more individual connections offers the advantage of improving by this means the average service level of a multiplicity of connections in the overall system.

Surprisingly, it is then even possible to improve the average service level of the multiplicity of connections even though the required service level value is degraded for the individual connection or for some of the multiplicity of connections.

It may be necessary to increase or to decrease the required service level value for the individual connection in order to improve the average service level of the multiplicity of connections depending on the operating situation in the overall system.

It is particularly advantageous to temporarily change the required service level value or values for the individual connection, a multiplicity of connections or advantageously all connections by a predetermined, particularly small amount compared with the service level value in each case supposedly required, since in the case of an improvement in the average service level of the multiplicity of connections, the service level value required in each case for the individual connection(s) can be correspondingly adapted. In the case of degradation, the required service level values are reset to the original value for a predetermined period of time or advantageously changed in the opposite direction.

Using a required signal-to-interference ratio value as the required service level value for the individual connection makes it possible to use the method with only minimal extensions of systems for power control already in existence. In particular, the required service level value can be used as reference value for controlling the power in a fast control loop, known per se.

The type of communication services used in the system and the number of subscribers or of existing connections in a radio cell, respectively, have a direct effect on the load in the system. Selecting the required service level value in dependence on the load and/or in dependence on other quantities, directly related to the load, of a multiplicity of connections or of all connections also makes it possible to use facilities known per se. Thus, measuring the total interference as a quantity related to the load is already known per se. However, the total interference values have hitherto been determined for completely different purposes in the field of management planning of the communication system.

Required service level values for various load situations in the system are advantageously stored in a look-up table from which they can be taken as required. The look-up table can be generated by simulations and/or by measuring actual connections in a first method step. It is also particularly advantageous that the look-up table can also be generated or updated during the operation so that later adaptations to changing conditions in the system or in a radio cell can be taken into consideration.

The formulation and handling of the values of the look-up table are particularly simple if it contains optimized ratio values of required service level values compared with a service level—particularly interference—measured during operation of the multiplicity of connections since such values are already taken into consideration in the existing standards and thus only a simple extension of the existing systems and devices is required. In particular, this also applies to the determination of the average service level of the multiplicity of connections by measuring the total throughput and the quality of service of the multiplicity of connections with temporary variations of the supposedly ideal values, in order to check these values.

A particular advantage of the method is based on the fact that, normally, the outer loop of a power control known per se is responsible for the service level of the individual connection. Since, for each connection, a separate algorithm is active for the outer loop, each connection is controlled individually in a decentralized manner in the case of a load change. This ultimately leads to very sluggish behavior.

Due to the central influence by the method listed above, however, it is also possible to act very rapidly on the individual connections. This provides for better quality for a large proportion of the connections if not for every single one.

To carry out such a method, stations for a radio communication system suitably have a changing device for detecting an average service level of a multiplicity of connections and for changing the required service level values for their individual connection(s) in order to improve the average service level of a multiplicity of own and/or other connections in their radio cell.

In the text which follows, an exemplary embodiment is explained in greater detail with reference to the drawing, in which:

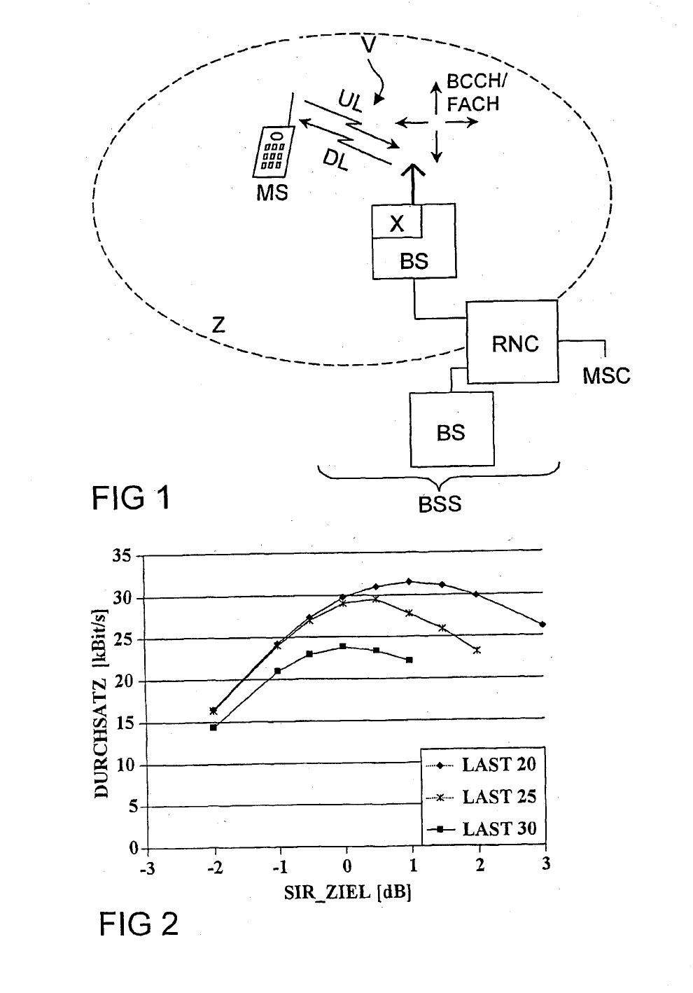

FIG. 1 shows a block diagram of a radio communication system, particularly a mobile radio system,

FIG. 2 shows a diagram for illustrating the relationship between throughput and target SIR in uplinks, and

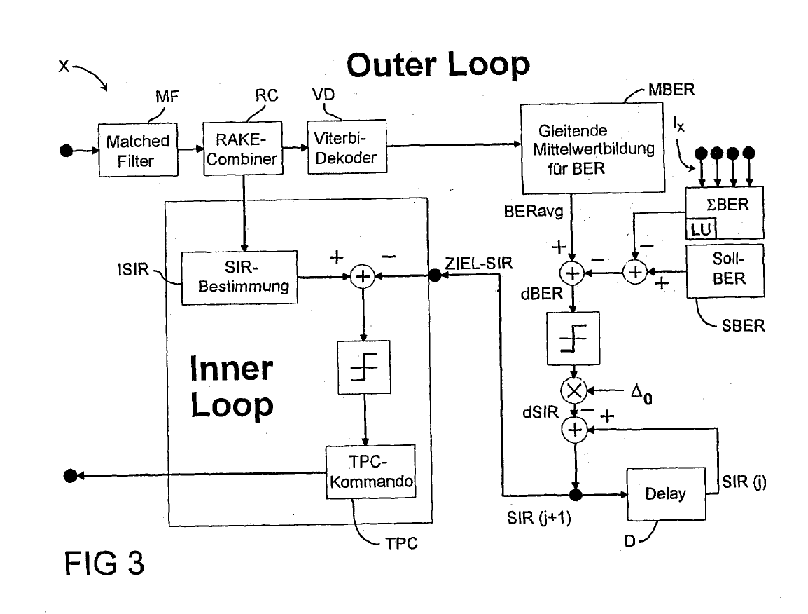

FIG. 3 shows a block diagram of an exemplary implementation of the inner and outer-loop in a transceiver of a base station or subscriber station, respectively.

FIG. 1 shows a part of a mobile radio system as an example of the structure of a radio communication system. A mobile radio system in each case consists of a multiplicity of mobile switching centers MSC which belong to a switching subsystem SSS and are networked together or, respectively, establish access to a landline network, and of in each case one or more base station subsystems BSS which are connected to these mobile switching centers MSC. A base station subsystem BSS, in turn, has at least one radio network controller RNC for assigning radio resources and at least one base station BS (also called node B) in each case connected thereto. A base station BS can set up connections to communication terminals or subscriber stations MS such as e.g. mobile stations or other mobile and stationary terminals via a radio interface V. Each base station BS forms at least one radio cell Z, BCCH, FACH. As a rule, the size of the radio cell Z is determined by the range of a general signaling channel (BCCH—Broadcast Control CHannel) which is transmitted by the base stations BS with a transmission power which is in each case fixed and constant. In the case of sectorization or of hierarchical cell structures, a number of radio cells Z can also be supplied for each base station BS. The function of this structure can be adopted for other radio communication systems in which the development described below can be used.

The example of FIG. 1 shows a subscriber station MS which is constructed as a mobile station. The subscriber station MS has set up a connection to the base station BS on which signals of a selected service are transmitted in the uplink UL and downlink DL.

The transmission power of the base station BS is controlled by the subscriber station MS by means of signaling messages (TPC commands) in which, for example, it maps a measured variation of the transmission characteristics into a required transmission power change. The transmission characteristics are characterized e.g. by the signal-to-interference ratio SIR and the bit error rate BER or their average value BERavg averaged over a time interval. The time interval selected for the averaging can be, for example, the periodicity of the outer loop. The characteristic value BER used is, for example, service level assessments such as a bit error rate BER or a block or frame erasure rate BLER.

To obtain the signal-to-interference ratio SIR, measured radio quantities such as path attenuation, an interference situation at the location of the subscriber station MS and combinations of these parameters are preferably used. Additionally or alternatively, the variation of the characteristic values BER and SIR can also be determined by means of the general signaling channel BCCH transmitted with a constant transmission power known to the subscriber station MS. The base station BS carries out the same method for controlling the transmission power of the subscriber station MS. After a corresponding evaluation of the transmission characteristics, it signals an increase or decrease in the transmission power to the subscriber station MS.

The diagram shown in FIG. 2 shows the relationship between the throughput of the overall system and the target SIR of an uplink with UDD64 service in W-CDMA (wideband CDMA). Such a diagram can be created, in particular, by means of computer simulation or by corresponding long-term measurements during operation. As can be seen from the three exemplary curves in the diagram, the value of the target SIR must be lowered with an increasing load in the overall system in order to be able to achieve the highest possible throughput for the totality of connections. Conversely, the value of the target SIR can be increased when the load in the overall system becomes less in order to be able to achieve the highest possible throughput of the totality of connections.

As explained below also with respect to FIG. 3 which represents a block diagram for power control for an individual connection, the outer loop is used both for transmission power control of the base station BS and for transmission power control of the subscriber station MS in a method and a circuit.

In the outer loop of the base station BS and of the subscriber station MS, a target value of a signal-to-interference ratio target SIR is determined and signaled in each case. The target value of the signal-to-interference ratio target SIR ensures an adequate transmission service level and must be adapted in accordance with the current transmission conditions. The respective inner loop can perform a particularly fast transmission power control. This fast transmission power control is effected via TPC (Transmitter Power Control) bits which in each case produce an increase or decrease in the transmission power by a particular value in dB.

FIG. 3 shows by way of example an implementation of the combination of an inner loop and an outer loop in a power control device X of a transceiver of the base station BS or also of the subscriber station MS. The received signals are filtered in a so-called matched filter MF and supplied to a detector device RC. In the example shown, the detector device RC is constructed as a known RAKE combiner.

In the inner loop, a signal-to-interference ratio SIR is determined in an SIR determining device ISIR from the detected signals supplied by the detector device RC. The signal-to-interference ratio SIR is used as the basis for optimum transmission power adjustment by the fast transmission power control since the interference situation at the receiver represents the most important criterion for reliable reception of the signals.

In the outer loop, the received signals are decoded in a decoding device VC, e.g. a Viterbi decoder, following the detector device RC. Following this, a service level value BER which is characteristic of the respective connection is determined in a service level determining device MBER. In the present circuit, averaging of a characteristic value such as the bit error rate BER is effected. This characteristic value BER is then compared with a target value for the characteristic service level value target BER in the outer loop and a difference dBER between the two values is calculated. The difference dBER is then recalculated into a correction value dSIR for the signal-to-interference ratio, e.g. by means of a weighting factor Δ₀ and other possibly nonlinear operations. This is followed by an addition with a target value for the signal-to-interference ratio SIR(j) of a preceding control interval j. In the same manner, the resultant current target value for the signal-to-interference ratio SIR(j+1) or target SIR, respectively, is delayed by one j step in this case by means of a delay device D and then taken into consideration for calculating the subsequent target value SIR(j+1). The current nominal value target SIR is supplied to the inner loop and is used for fast transmission power control in the inner loop as a basis for increasing or decreasing the transmission power by signaling TPC bits. The higher the load in the overall system, the smaller the current nominal value target SIR should be.

In the method described below, the target SIR in a radio cell Z is adjusted in dependence on the load prevailing in the network or, respectively, in dependence on other quantities which are directly related to the load.

The load prevailing in the network cannot be determined directly, in general. Instead, the total interference ΣSIR is measured by the base station BS as described above and the target SIR is adjusted in dependence on this quantity. Measuring the total interference ΣSIR as such is already provided for providing resources in the standard.

The target SIR can be adjusted by means of look-up tables LU. These look-up tables LU contain optimized ratio values of target SIR compared with a measured interference SIR. The look-up tables LU can be obtained e.g. by simulations as have been used for creating the diagrams of FIG. 2.

As an alternative, it is also possible to create and/or update such look-up tables LU by measuring the values at representative radio stations BS, MS during network operation. For this purpose, for example, the target SIR can be shifted in small steps compared with the optimum value according to a simulation or existing look-up table LU in certain phases of the operation. The target SIR values of a multiplicity of or all connections are advantageously simultaneously shifted by small amounts. In these phases, detailed measurements of the total throughput and of the quality of service are carried out. If these quantities increase during the variation, the target SIR is no longer optimum for the totality of connections and is adapted in a subsequent step. During the adaptation, it is also possible, in particular, to correct the look-up table LU. In other words, a poorer service level is accepted for individual connections in order to ultimately achieve a better service level for the totality of connections.

As can be seen from FIG. 3, the block diagram for power control has one or more other inputs Iₓ into which values of the current total interference or of the current total load proportional thereto for a multiplicity of or preferably all connections are entered. Using the current total load determined during this process, the look-up table LU described above is entered for determining a correction value for the target SIR. Using this correction value, the value of the target bit error rate is finally changed via e.g. an adder or a multiplication device. This is used for directly influencing the outer loop and indirectly the inner loop.

Naturally, the last method steps mentioned, in particular, can also take place in a single device which has one or more inputs for the instantaneous load value or values and one or more look-up tables LU for determining a suitable nominal value which is then processed with the respective value from the devices for determining the average values for the bit error rate or the like.

In summary, it must be noted that, according to the above method, a service level value required for the ideal case is changed, particularly degraded, for an individual connection in order to improve the average service level of a multiplicity of connections.

1. A method for controlling the transmission power of stations (BS, MS) in a radio communication system for administering a multiplicity of connections (V) between individual stations (BS, MS) communicating with one another over a radio interface (V, BCCH, FACH), in which a corresponding service level value (target SIR) is set for each individual connection (V) in order to achieve a required service level (SBER), and the service level value (target SIR) for the individual connection (V) is changed in order to improve an average service level (ΣBER) of a multiplicity of connections (V).

2. The method as claimed in claim 1, in which the service level value (target SIR) for the individual connection (V) is degraded in order to improve the average service level (ΣBER) of the multiplicity of connections (V).

3. The method as claimed in claim 1 or 2, in which the service level value (target SIR) for the individual connection (V) is increased or decreased in order to improve the average service level (ΣBER) of the multiplicity of connections (V).

4. The method as claimed in claim 3, in which
the service level value (target SIR) for the individual connection (V), a multiplicity of connections or all connections is temporarily changed by a predetermined, particularly small amount compared with the supposedly required service level value (target SIR), and
the service level value (target SIR) for the individual connection(s) (V) is correspondingly adapted if the average service level (ΣBER) of the multiplicity of connections (V) improves.

5. The method as claimed in a preceding claim, in which the service level value (target SIR) for the individual connection (V) is a required signal-to-interference ratio value (SIR).

6. The method as claimed in a preceding claim, in which the service level value (target SIR) is used as reference value for controlling the power in a fast control loop.

7. The method as claimed in a preceding claim, in which the service level value (target SIR) is selected in dependence on the load and/or in dependence on other quantities directly related to the load, particularly the interference, of a multiplicity of connections (V) or of all connections (V).

8. The method as claimed in a preceding claim, in which the service level value (target SIR) is at least taken from a look-up table (LU).

9. The method as claimed in claim 8, in which the at least one look-up table (LU) is created by simulations and/or by measurements of actual connections in a first method step and/or is updated during operation.

10. The method as claimed in claim 8 or 9, in which the at least one look-up table (LU) contains optimized ratio values of required service level values (target SIR) compared with a service level measured in operation (ΣBER), particularly interference (SIR), of the multiplicity of connections.

11. The method as claimed in a preceding claim, in which, in order to determine the average service level (ΣBER) of the multiplicity of connections (V), measurements of the total throughput and of the quality of service of the multiplicity of connections (V) are performed.

12. A radio communication system, particularly for carrying out the method as claimed in claim 1, with a multiplicity of stations (BS, MS) which at least partially exhibit the following:
at least one transmitting and receiving device for setting up and administering communication connections (V) via radio interfaces (V, BCCH, FACH) between individual ones of the stations (BS, MS),
at least one control device (X) for controlling the respective transmission power,
at least one storage device (LU, SBER) for storing and providing service level values (target SIR) for achieving a required service level (SBER) for each individual connection (V), and
a changing device (ΣBER, LU) for detecting an average service level (ΣBER) of a multiplicity of connections (V) and for changing the service level values (target SIR) for the individual connection (V) in order to improve the average service level (ΣBER) of a multiplicity of connections (V).

13. A station (BS, MS) for a communication system as claimed in claim 13, characterized in that the station is a base station (BS) or a data terminal, particularly a mobile station (MS).
